(19) United States
(12) Patent Application Publication
(10) Pub. No.: US 2016/0189083 A1
(43) Pub. Date: Jun. 30, 2016

(54) SYSTEM AND METHOD FOR PROVIDING FUTURE INDICATORS OF SUCCESS STATISTICS FOR A LARGE POOL OF CANDIDATES

(71) Applicant: Jin Kristeen GEIGER, Jackson Heights, NY (US)

(72) Inventor: Jin Kristeen GEIGER, Jackson Heights, NY (US)

(21) Appl. No.: 14/984,451

(22) Filed: Dec. 30, 2015

Related U.S. Application Data
(60) Provisional application No. 62/098,703, filed on Dec. 31, 2014.

(51) Int. Cl. G06Q 10/06; G06Q 10/10

(52) U.S. Cl. CPC G06Q 10/06393; G06Q 10/1053

(57) ABSTRACT

A job matching system and method for determining future indicators of success statistics for a large pool of candidates is provided. The future indicators of success statistics are enabled for reporting by an online portal system generating and comparatively analyzing a statistically relevant number of industry-specific test results for the large pool of candidates. The online portal system provides a candidate-facing portion and an interconnected recruiter-facing portion that facilitate the large pool of candidates to generate the statistically relevant number of industry-specific test results.

### CROSS-REFERENCE TO RELATED APPLICATION

This application claims the benefit of priority of U.S. provisional application No. 62/098,703, filed 31 Dec. 2014, the contents of which are herein incorporated by reference.

### BACKGROUND OF THE INVENTION

The present invention relates to a method and system for matching candidate qualification to position requirements, and more particularly to a job matching system and method that provides future indicators of success statistics for a statistically relevant number of candidates by generating and comparatively analyzing industry-specific data results for the candidates.

Hiring managers do not generally test job applicants for certain skills like industry knowledge, analytical reasoning or ethics. Even if some testing is executed, the sample set for score comparison is generally very small. Hiring is often based on personality, not ability, which leads to disappointment and frustration on all sides and decreases efficiency as hires require unanticipated training or replacement.

There are no metrics around future indicators of success derived from a candidate's full life cycle of application, interview, offer, hire, promotion, length of employment, etc.

There is no test available that can provide recruiters with a quantified view of the talent pool at large.

Existing systems don't provide a large scale base of applicants and therefore the scores are difficult to interpret or correlate to successful hires.

Other firms do not reach out to the job seekers on a large scale to provide them with a way to take the test in order to garner the attention of recruiters/hiring managers.

Other systems stop with the hiring process instead of following the candidate's career. Without this information there are no metrics around future indicators of success.

As can be seen, there is a need for a job matching system and method that provides future indicators of success statistics for a statistically relevant number of candidates by generating and comparatively analyzing industry-specific data results for the candidates.

### SUMMARY OF THE INVENTION

In one embodiment of the present invention, a computer-implemented method for identifying at least one candidate from a statistically relevant number of candidates by generating and comparatively analyzing industry-specific data results for the candidates includes providing an online portal hosting a plurality of industry-specific tests; apportioning the online portal into a candidate-facing portion and a interconnected recruiter-facing portion, wherein the candidate-facing portion comprises a plurality of candidate profiles, and wherein the recruiter-facing portion comprises a plurality of recruiter profiles; and conditioning a registration of each of the plurality of candidate profiles in part on producing industry-specific test results associated with at least one of the plurality of industry-specific tests.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a job matching system and method that provides future indicators of success statistics for a statistically relevant number of candidates through large pool of candidates by generating and comparatively analyzing industry-specific data. The job matching system provides two primary components. First, a process to identify and report on job candidates, including industry relevant test scores, job history and application of such to a larger pool of data for analysis. Second, a web-based portal that embodies the first process, wherein the web-based portal provides for employment and educational candidates and recruiters to input and access the above-mentioned industry-specific data.

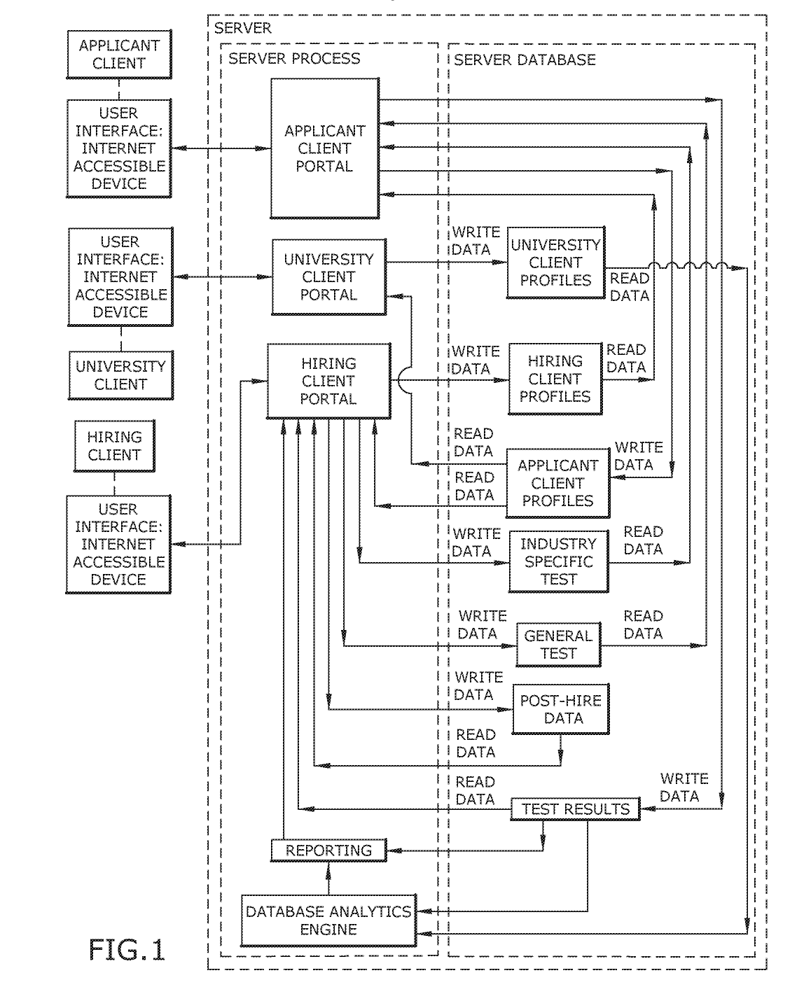

Referring to FIG. 1, the system of the present invention may include a plurality of industry-specific tests and a plurality of global standardized tests (herein “test” or “tests”) hosted on an online portal. The industry-specific may be adapted to add different questions thereto over time, allowing it to develop as the associated industry develops. In an educational setting, the industry-specific tests may relate to scholastic subject matters found therein. The global standardized tests may include measurements of skills and qualifications that are applicable across a variety of industries.

The online portal may include a candidate-facing portion and a recruiter-facing portion. The candidate-facing portion may be accessible by a plurality of candidates from a plurality of industries, and the recruiter-facing portion may be accessible by a plurality of recruiter from the plurality of industries. Generally speaking, the candidates may be offering quantifiable skills for at least one predetermined position associated with the plurality of industries, while the recruiters may be offering the at least one predetermined position associated with the plurality of industries. Recruiters may be hiring managers, educational registrars, and the like. Candidates may be job seekers or prospective students. The candidate-facing portion of the online portal may enable candidate users to promote their qualitative skills through the publishing of their test results and uploading resumes, work samples, photos, and other components of candidate profiles. The recruiter-facing portion of the online portal may enable recruiter users to condition acceptance of an application for a position on predetermined the test results of at least one test.

Such multifaceted apportioning may generate a statistically significant number of test taking candidates to provide a sufficient basis for statistical analysis of their test results. The system is adapted so that such test results may be exportable and able to saved and filtered.

Furthermore, the recruiter-facing portion may enable recruiters to create key data sets of performance indicators associated with all candidates, including but not limited to, job offer, length of employment, promotions, region, and industry.

Such key data sets are exportable, able to saved and filtered. In certain embodiments, the recruiter-facing portion may enable recruiters to search through the entirety of the plurality of candidates using customized score thresholds and other relevant criteria past experience, degree, language, geography, etc. The online portion may provide at least one database of user profiles and flexible reporting tool for accessing the contents of the at least one database.

A method of using the present invention may include the following. A candidate may create a candidate profile on the candidate-facing portion of the online portal to register for at least one of the tests. The candidate profile enables candidates to access, take and produce test result for at least one test. The test will be available via online portal and secured through standard web protocol. The website will be multi-browser enabled and eventually allow limited access via mobile. In certain embodiments, the test could be delivered in written form, without a computer.

In certain embodiments, candidates can take at least one test but if unhappy with their test results, can choose not to publish them. The candidate profile may prompt each candidate to provide associated key performance indicators. The candidate profile may be viewable by recruiters. The candidate profile may enable associated candidates to alert recruiters of availability; demonstrate relevant skills evidenced by test results; view analytics regarding successful candidates receiving offers, length of time between interview and offer associated with predetermined recruiters, etc. Recruiters create online recruiter profiles to access the recruiter-facing portion of the online portal. The recruiter-facing portion enables recruiters to search for through the database of candidates profiles, save such searches, contact candidates, view analytics based in part on the test results and the key performance indicators of a desires candidate, receive notifications regarding the status/results of predetermine candidates, and save and filter a plurality of candidate events, such as phone interview, in-person interview, job offer, job acceptance, hire date, subsequent promotions, and other post-hire information. Additionally, logic gates and queries can be set up by recruiter profiles to filter candidate-profile searches based on flexible criteria: geography, language, availability, test score, answers to specific questions, etc.

The recruiter profile enables recruiters to post positions, such as job offerings. Post job descriptions and view analytics regarding their position hiring process and post hiring success via geography, industry, etc.

In certain embodiments, educational institutions, such as universities, may create profiles to request a test session on campus, view analytics and promote the test to students, wherein the educational institutions are the recruiters, the students are the candidates, and the industry-specific tests pertain in part to scholastic subject matters.

The recruiter-facing and the candidate-facing portions can operate separately or together depending on client requirements. Example: Recruiter A requires job seekers to take all sections of the test before being able to apply for the job. While Recruiter B does not require a test score and uses the portal to search for candidates.

Moreover, portal and reporting components are integrated to at least one database and can be enhanced, added to, removed and accessed independently based on user roles. As a result of these flexible reporting tools, all user types and the parameters available are set by the role. Example: candidates can see the number of hires in the past 6 months with a test score above X while recruiters can see the length of employment of hires in the past 6 years for a city or region. In this way, a plurality of position parameters related to the at least one position are searchable by the plurality of candidate profiles.

It should be understood, of course, that the foregoing relates to exemplary embodiments of the invention and that modifications may be made without departing from the spirit and scope of the invention as set forth in the following claims.

What is claimed is:

1. A computer-implemented method for identifying at least one candidate from a statistically relevant number of candidates by generating and comparatively analyzing industry-specific data results for the candidates, comprising:
providing an online portal hosting a plurality of industry-specific tests;
apportioning the online portal into a candidate-facing portion and a interconnected recruiter-facing portion, wherein the candidate-facing portion comprises a plurality of candidate profiles, and wherein the recruiter-facing portion comprises a plurality of recruiter profiles; and
conditioning a registration of each of the plurality of candidate profiles in part on producing industry-specific test results associated with at least one of the plurality of industry-specific tests.

2. The method of claim 1, further comprising adding at least one question to each of the plurality of industry-specific tests for every associated industry development.

3. The method of claim 2, wherein the online portal further hosts a plurality of global standardized tests.

4. The method of claim 3, further prompting each of the plurality of candidate profiles to provide associated key performance indicators.

5. The method of claim 4, wherein the industry-specific test results and the key performance indicators are searchable by the plurality of recruiter profiles.

6. The method of claim 5, further enabling each of the plurality of recruiter profiles to publish at least one position searchable by the plurality of candidate profiles.

7. The method of claim 6, further enabling each of the plurality of recruiter profiles to export a plurality of candidate events.

8. The method of claim 7, further conditioning the associated one of the plurality of recruiter profiles to maintain a plurality of position parameters related to the at least one position, wherein the plurality of position parameters are searchable by the plurality of candidate profiles.

9. The method of claim 8, further comparatively analyzing the searchable industry-specific test results and the key performance indicators of the plurality of candidate profiles.

10. The method of claim 9, further comparatively analyzing the searchable plurality of position parameters of the plurality of recruiter profiles.
